(19) United States
(12) Patent Application Publication
(10) Pub. No.: US 2026/0084469 A1
(43) Pub. Date: Mar. 26, 2026

(54) RADIAL TYRE

(71) Applicant: Nokian Renkaat Oyj, Nokia (FI)

(72) Inventors: Dietmar DAMM, München (DE); Samu LEPISTÖ, Nokia (FI); Jarno RÖYTIÖ, Nokia (FI); Stefano SGRO, Nokia (FI); Joonas JUNTTILA, Nokia (FI); Arttu VIHAVAINEN, Ylöjärvi (FI)

(21) Appl. No.: 19/333,647

(22) Filed: Sep. 19, 2025

(30) Foreign Application Priority Data
Sep. 23, 2024 (EP) 24201973.5

(51) Int. Cl. B60C 15/02; B60C 13/00; B60C 15/04

(52) U.S. Cl. CPC B60C 15/02; B60C 13/00; B60C 15/04; B60C 2200/04

(57) ABSTRACT

The radial tire for a passenger car or SUV is configured to be mounted onto a rim having a nominal diameter in the range of 13 to 24 inches and the bead diameter (DH) of the bead region of the tire is 1.6-2.4 mm smaller than the rim diameter (D) specified for the corresponding rim size in the ETRTO standard for rims of passenger cars, LCVs and trailers.

### PRIORITY

This application claims priority of European Patent Application 24201973.5 filed on Sep. 23, 2024.

### TECHNICAL FIELD OF THE INVENTION

The invention concerns a radial tire for a passenger car or SUV, as defined in claim 1.

### BACKGROUND OF THE INVENTION

Passenger cars, light commercial vehicles, SUVs and other similar vehicles are usually provided with pneumatic radial tires. As the tires provide the only contact points between the vehicle and the ground, the properties of the tires play a crucial role in the performance, handling properties and safety of vehicles. The tires must allow safe and comfortable driving in various conditions and situations. For instance, the tires must function both in dry and wet weather, in various temperatures and on different surfaces and at different speeds. Improving of a single property of a tire could be relatively easy, but improving of the overall performance of a tire is very challenging due to many conflicting requirements.

The parts of the outer surface of a typical radial tire include a tread, sidewalls and bead areas. The bead areas contact the rim, and the design and construction of the bead areas has a significant effect on the properties of the tire.

### SUMMARY OF THE INVENTION

An object of the invention is to provide an improved radial tire for a passenger car or SUV.

The tire according to the invention is configured to be mounted onto a rim having a nominal diameter in the range of 13 to 24 inches. The bead diameter of the bead region of the tire is 1.6-2.4 mm smaller than the rim diameter specified for the corresponding rim size in the ETRTO standard for rims of passenger cars, LCVs and trailers.

The tire according to the invention stays firmly on the rim and has improved handling properties on dry, wet and snowy roads.

According to an embodiment of the invention, the bead diameter is 1.8-2.2 mm smaller than said rim diameter.

According to an embodiment of the invention, the ratio between the diameter of a seam between the bead region and the sidewall of the tire and said bead diameter is

$${a}_{min} \times {D}^{2} + {b}_{min} \times D + {c}_{min} \leq \frac{D S}{D H} \leq {a}_{max} \times {D}^{2} + {b}_{max} \times D + {c}_{max} ,$$

where D is said rim diameter, DS is said diameter of the seam and DH is said beam diameter, and

$${a}_{min} = 4.237 \cdot {10}^{- 7} {mm}^{- 2}$$

$${b}_{min} = - 5.944 \cdot {10}^{4} {mm}^{- 1}$$

$${c}_{min} = 1.2 \; 72$$

$${a}_{max} = 4 \text{.769} \cdot {10}^{- 7} {mm}^{- 2}$$

$${b}_{max} = - 6 \text{.686} \cdot {10}^{- 4} {mm}^{- 1}$$

$${c}_{max} = 1.305 .$$

With the ratio defined above, the handling properties of the tire are further improved and the tire gets good support from the side surface in extreme situations. The dimensioning also facilitates mounting of the tire.

According to an embodiment of the invention, the constants and coefficients in the formula above are

$${a}_{min} = 4.264 \cdot {10}^{- 7} {mm}^{- 2}$$

$${b}_{min} = - 5.981 \cdot {10}^{- 4} {mm}^{- 1}$$

$${c}_{min} = 1.2 \; 73$$

$${a}_{max} = 4 \text{.741} \cdot {10}^{- 7} {mm}^{- 2}$$

$${b}_{max} = - 6 \text{.648} \cdot {10}^{- 4} {mm}^{- 1}$$

$${c}_{max} = 1.303 .$$

According to an embodiment of the invention, the sidewall of the tire is provided with a protrusion forming a rim protector located radially outwards from a seam between the bead region and the sidewall of the tire.

According to an embodiment of the invention, the rim protector comprises a tip having an inner edge and an outer edge, the inner edge being located closer to the rotation axis of the tire than the outer edge, and the lateral distance from a laterally outwards facing rim contact area of the bead region of the tire to said inner edge of the tip of the rim protector is 13.5-20.0 mm. According to an embodiment of the invention, the lateral distance is 15.5-18.0 mm. The dimensions facilitate mounting of the tire.

According to an embodiment of the invention, the ratio between the diameter of the circumference where an inner edge of a tip of the rim protector is located and the bead diameter is

$${d}_{min} \times {D}^{2} + {e}_{min} \times D + {f}_{min} \leq \frac{D P}{D H} \leq {d}_{max} \times {D}^{2} + {e}_{max} \times D + {f}_{max} ,$$

where D is said rim diameter, DP is said diameter of the circumference, DH is said bead diameter, and

$${d}_{min} = 4 \text{.912} \cdot {10}^{- 7} {mm}^{- 2}$$

$${e}_{min} = - 6 \text{.890} \cdot {10}^{- 4} {mm}^{- 1}$$

$${f}_{min} = 1.3 \; 15$$

$${d}_{max} = 6 \text{.507} \cdot {10}^{- 7} {mm}^{- 2}$$

$${e}_{max} = - 9 \text{.122} \cdot {10}^{- 4} {mm}^{- 1}$$

$${f}_{max} = 1.416 .$$

According to an embodiment of the invention, the constants and coefficients in the formula above are

$${d}_{min} = 5.362 \cdot {10}^{- 7} {mm}^{- 2}$$

$${e}_{min} = - 7 \text{.520} \cdot {10}^{- 4} {mm}^{- 1}$$

$${f}_{min} = 1.3 \; 43$$

$${d}_{max} = 6 \text{.054} \cdot {10}^{- 7} {mm}^{- 2}$$

$${e}_{max} = - 8.488 \cdot {10}^{- 4} {mm}^{- 1}$$

$${f}_{max} = 1.387 .$$

According to an embodiment of the invention, the angle between the outer surface of the bead region and the outer surface of the sidewall of the tire at the seam of the bead region and the sidewall is at most 180 degrees. According to an embodiment of the invention, the angle is at least 170 degrees. With the angles defined above, the handling properties of the tire are further improved and the side surface provides good support in extreme situations.

According to an embodiment of the invention, the bead width from the toe of the bead region of the tire to a laterally outwards facing rim contact area of the bead region is 14.8-16.2 mm measured in a direction that is parallel to the rotation axis of the tire. According to an embodiment of the invention, the bead width is 14.8-15.2 mm in case the tire comprises a single carcass ply and 15.8-16.2 mm in case the tire comprises two carcass plies. The dimensioning increases the compression force of the tire on the rim and ensures that the tire stays firmly on the rim.

### BRIEF DESCRIPTION OF THE DRAWINGS

Embodiments of the invention are described below in more detail with reference to the accompanying drawings, in which

FIG. 1 shows an example of a radial tire,

FIG. 2 shows a cross-sectional view of components of a radial tire,

FIG. 3 shows an enlarged view of part of the tire of FIG. 2,

FIG. 4 shows an example of a rim profile,

FIG. 5 shows a schematic view of a tire mounted onto a rim, and

FIG. 6 shows the bead region and a lower part of the sidewall of a tire according to an embodiment of the invention.

### DETAILED DESCRIPTION OF EMBODIMENTS OF THE INVENTION

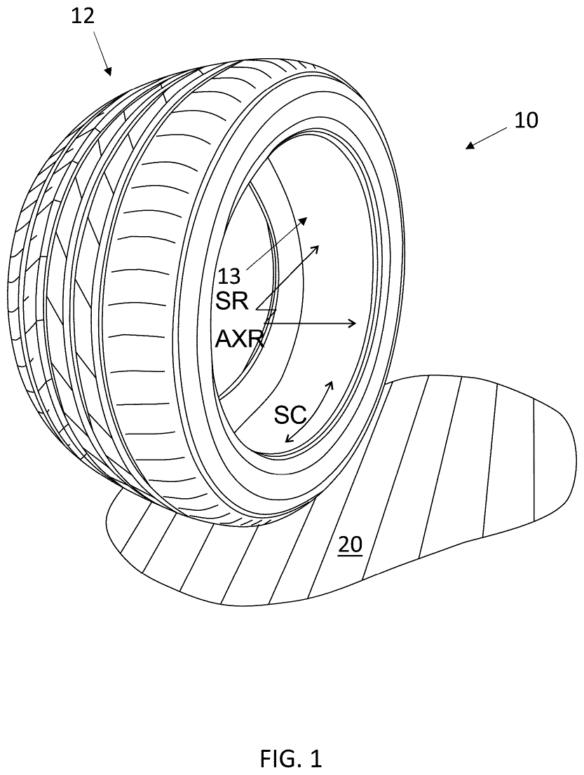

FIG. 1 shows an example of a radial tire 10. The tire 10 is a pneumatic tire for a passenger car or a SUV, although the tire 10 could also be used in other vehicles. The tire 10 is configured to be mounted onto a rim having a nominal diameter in the range of 13 to 24 inches.

The tire 10 is configured to be rotatable around an axis of rotation AXR. Arrow SR in FIG. 1 denotes the radial direction of the tire 10 and arrow SC denotes the circumferential direction of the tire 10.

The tire 10 comprises a tread 12, which is configured to be in contact with a surface 20, such as a road surface, during the normal use of the tire 10. The tread 12 comprises a tread pattern, which comprises a plurality of tread blocks. The tire 10 has an inner surface 13, which faces inwards and is therefore not visible during the normal use of the tire 10 when the tire 10 is mounted onto a rim.

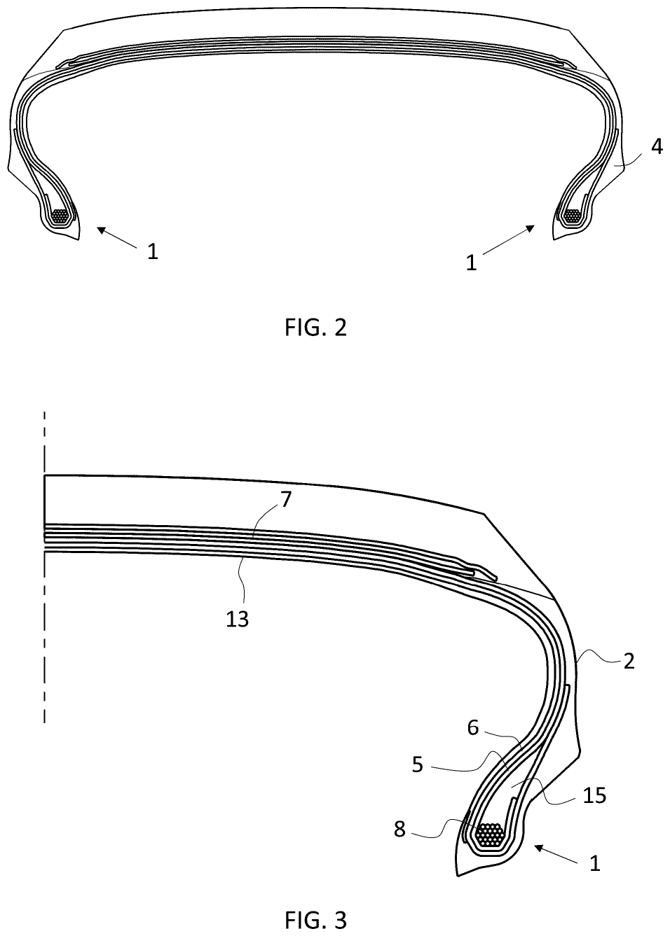

FIG. 2 shows as a cross-sectional view an example of typical components of a radial tire 10. FIG. 3 shows an enlarged view of part of the tire 10 to better illustrate the components of the tire 10. It should be noted that different tires 10 may comprise different components. A radial tire 10 can thus comprise even other components than those shown in the figures, and/or not all tires 10 comprise all the components described below. The tread 12 of the tire 10 is not shown in FIGS. 2 and 3.

The tire 10 comprises a bead 1 on each side of the tire 10. The term “bead” refers to the area that is configured to contact a rim when the tire 10 is mounted onto the rim. Each bead 1 extends in the circumferential direction over a whole circle. The bead 1 has a toe that faces in the lateral direction of the tire 10 towards an imaginary center plane of the tire 10 and a heel that faces laterally outwards from the center plane of the tire 10. Many components of the tire 10 extend to one or both of the bead regions of the tire 10.

The tire 10 typically comprises at least one reinforcing belt, i.e., a circumferential layer 7, which is arranged between the inner surface 13 of the tire 10 and the tread 12 of the tire. In the example of FIGS. 2 and 3, the tire 10 comprises two belts 7. The belts 7 can be made of the same material or of different materials.

The circumferential belts 7 can comprise metal. The circumferential belts 7 may comprise steel, or they may consist of steel. The circumferential belts 7 may be wire-like structures arranged inside the tire 10. At least one of the circumferential belts 7 may comprise a steel mesh. In addition, or alternatively, the circumferential belts 7 may comprise fibrous material. The fibrous material of a circumferential belt 7 may comprise at least one of cotton, rayon, polyamide (Nylon), polyester, polyethylene terephthalate, and poly-paraphenylene terephthalamide (Kevlar). The tire 10 could comprise, for instance, two steel belts and one or more belts made of a fibrous material and arranged radially outwards from the steel belts.

The body of the tire 10 comprises at least one carcass ply 5, 6. In the example of FIGS. 2 and 3, the tire 10 comprises two carcass plies 5, 6. The carcass plies are material layers, typically textile layers. Each carcass ply 5, 6 extends from a first bead region of the tire 10 to a second bead region on the other side of the tire 10. Each ply fabric can be made of e.g. polyester. The plies can be coated with rubber to seal the tire and to bond the layers with each other.

The carcass ply/plies 5, 6 may comprise fibrous material. The fibrous material of the carcass ply 5, 6 can comprise
cotton, and/or
rayon, and/or
polyamide (Nylon), and/or
polyester, and/or polyethylene terephthalate, and/or
Poly-paraphenylene terephthalamide (Kevlar).

The tire 10 further comprises an outer sidewall 2. The outer sidewall 2 of the tire 10 can be used to protect the side of the tire e.g. from the road. The outer visible tire sidewalls 2 can be of a rubber composition.

The tire 10 may further comprise an inner liner 13, which inner liner 13 of the tire is typically an airtight layer of rubber.

Each bead 1 of the tire 10 is configured to allow the tire 10 to be mounted onto a rim. The bead 1 comprises a rubber composition that forms a mounting surface of the tire 10. The bead 1 further comprises a bead core (bead wire) 8 and an apex (bead filler) 15. The bead core 8 is formed by a wire bundle. The bead core 8 can be constructed by wrapping a single strand of rubber-coated bead wire into a bundle. The bead core 8 can have a substantially circular cross-sectional shape or some other shape, such as a drop shape. The apex 15 may be a filler of elastomeric material.

The carcass plies 5, 6 extend from one side of the tire 10 to the other side and the carcass plies 5, 6 are turned around the bead core 8 and at least part of the apex to the external side of the tire 10. In the examples of the figures, the outer carcass ply 6 extends farther from the bead core 8.

To manufacture a tire, a pre-formed apex 15 can be connected to the bead core 8 with a machine. Thus, a bead assembly can be preassembled from the bead core 8 and the apex 15. The apex 15 can be, for example, an extruded strip. The tire 10 can be pre-formed, and the assembly can be combined to a tire carcass. Finally, the tire 10 can be vulcanized, e.g., in a curing press.

A method for manufacturing a pneumatic tire can thus comprise the following steps:
connecting a preformed apex to a bead core, thereby forming an assembly comprising the bead core and the apex,
preforming a tire comprising said assembly, and
vulcanizing the preformed tire, thereby obtaining the tire.

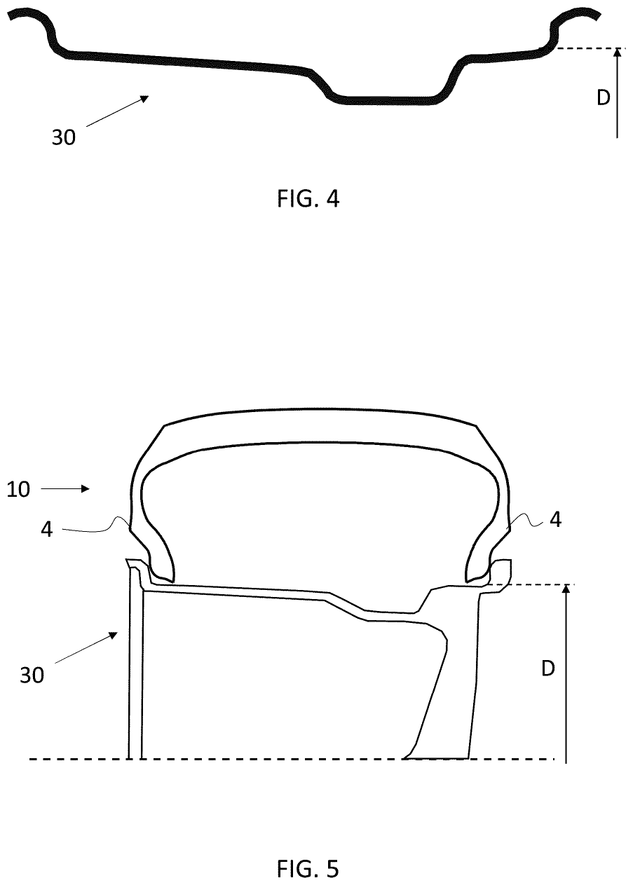

FIG. 4 shows an example of a profile of a rim 30. The dimensions of rims are standardized by the standards of the European Tyre & Rim Technical Organisation (ETRTO). The rims of passenger car tires are covered by a standard covering rims for passenger cars, light commercial vehicles and trailers. Many dimensions of the rims are specified in the standard as minimum and/or maximum dimensions. One dimension specified in the standard is the rim diameter D. Each rim has a nominal size expressed in inches. The nominal sizes vary from 10 to 30 inches. For each nominal size, there is a specific rim diameter D. The rim diameter D is measured from a position where the heel of the tire 10 contacts the rim 30. As an example, the rim diameter D of a common wheel size 17 inches is 436.6 mm.

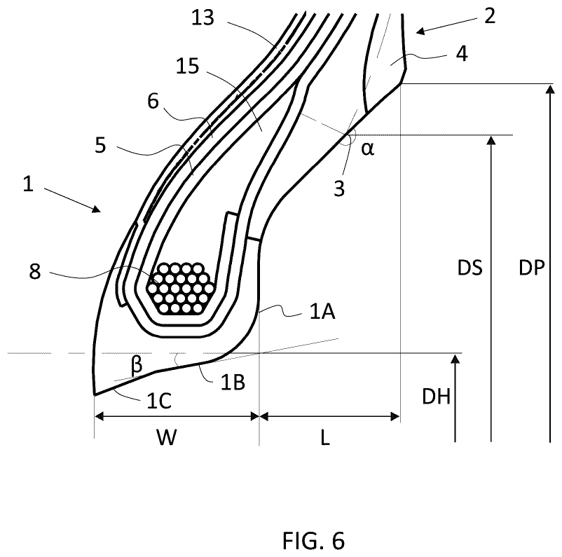

The dimensioning of the tire 10 according to the present invention is described by referring to FIG. 6. The tire 10 according to the invention has a bead diameter DH. The bead diameter DH of the tire 10 is the diameter of the bead 1 at a position where the heel of the tire 10 is configured to contact the rim 30. According to the invention, the bead diameter DH is 1.6-2.4 mm smaller than the rim diameter D specified for the corresponding rim size in the ETRTO standard for rims of passenger cars, LCVs and trailers.

The tire according to the invention stays firmly on the rim and has improved handling properties on dry, wet and snowy roads.

According to an embodiment of the invention, the bead diameter DH is 1.8-2.2 mm smaller than the rim diameter D.

More specifically, the bead diameter DH can be defined as the diameter of a circle on which an imaginary extension of an ankle portion that is perpendicular to the rotation axis of the tire and an imaginary extension of an outer portion of the bead base of the tire intersect.

FIG. 6 shows part of a tire 10 according to an embodiment of the invention in a use position. The bead region 1 of the tire 10 has a bead base (sole) that extends from the toe to the heel of the tire. The bead base comprises an outer portion 1B and an inner portion 1C. The outer portion 1B is located laterally farther from an imaginary center plane of the tire 10 than the inner portion 1C. The center plane means here a plane that is perpendicular to the rotation axis AXR of the tire 10.

In a cross-sectional view each of the outer portion 1B and the inner portion 1C of the bead base is straight.

The angle β between the outer portion 1B of the bead base and a line that is parallel to the rotation axis AXR of the tire 10 can be referred to as a first toe angle. In the embodiment of FIG. 6, the first toe angle β is 10 degrees. The angle between the inner portion 1C and a line that is parallel to the rotation axis AXR of the tire 10 can be referred to as a second toe angle. In the embodiment of FIG. 6, the second toe angle is greater than the first toe angle β. The bead region 1 has a laterally outwards facing rim contact area 1A, where the bead 1 of a mounted tire is in contact with the rim 30. The rim contact area 1A has a portion that is perpendicular to the rotation axis AXR of the tire 10. The bead diameter DH is the diameter of the circle where the imaginary extensions of the outer portion 1B of the bead base and the rim contact area 1A intersect.

The side walls 2 of the tire 10 are typically manufactured as separate extruded parts that are pressed onto the body of the tire 10 during assembly of the tire 10. Each side wall 2 of the tire 10 connects to the bead region 1 at a seam 3, which extends circumferentially around the whole tire 10. The inner edge of the side wall part in the radial direction of the tire 10 is thus located at the seam 3. The seam 3 has a diameter DS. According to an embodiment of the invention, the seam 3 is positioned such that the ratio DS/DH is within the range defined by the following formula:

$${a}_{min} \times {D}^{2} + {b}_{min} \times D + {c}_{min} \leq \frac{D S}{D H} \leq {a}_{max} \times {D}^{2} + {b}_{max} \times D + {c}_{max} ,$$

where D is said rim diameter, and

$${a}_{min} = 4.237 \cdot {10}^{- 7} {mm}^{- 2}$$

$${b}_{min} = - 5.944 \cdot {10}^{- 4} {mm}^{- 1}$$

$${c}_{min} = 1.2 \; 72$$

$${a}_{max} = 4.7 \; 69 \cdot {10}^{- 7} {mm}^{- 2}$$

$${b}_{max} = - 6.6 \; 86 \cdot {10}^{- 4} {mm}^{- 1}$$

$${c}_{max} = 1.305 .$$

Preferably, the coefficients and constants in the formula defined above are

$${a}_{min} = 4.264 \cdot {10}^{- 7} {mm}^{- 2}$$

$${b}_{min} = - 5.981 \cdot {10}^{- 4} {mm}^{- 1}$$

$${c}_{min} = 1.2 \; 73$$

$${a}_{max} = 4.7 \; 41 \cdot {10}^{- 7} {mm}^{- 2}$$

$${b}_{max} = - 6.6 \; 48 \cdot {10}^{- 4} {mm}^{- 1}$$

$${c}_{max} = 1.303 .$$

With the ratio DS/DH in the ranges defined above, performance of the tire can be optimized while ensuring easy mounting of the tire. If the seam diameter DS is too large, the performance of the tire is compromised, while too small seam diameter will make the mounting of the tire more difficult.

In the embodiment of FIG. 6, the sidewall 2 of the tire 10 is provided with a protrusion 4 that forms a rim protector located radially outwards from the seam 3 between the bead region 1 and the sidewall 2 of the tire 10. The rim protector 4 protects the rim 30 from external impacts.

In the embodiment of FIG. 6, the rim protector 4 comprises a tip having an inner edge and an outer edge. The inner edge refers here to the edge that is located closer to the rotation axis AXR of the tire 10 than the outer edge. In the embodiment of FIG. 6, the laterally outermost point of the rim protector 4 is located on the outer edge of the tip of the rim protector 4.

The tire 10 is preferably configured such that the lateral distance L, measured in a direction that is parallel to the rotation axis AXR of the tire 10, from the rim contact area 1A of the bead region 1 of the tire 10 to the inner edge of the tip of the rim protector 4 is 13.5-20.0 mm. More preferably, the lateral distance L is 15.5-18.0 mm.

The rim protector 4 has a circumference where the inner edge of the tip of the rim protector 4 is located. The diameter of the circumference is DP. According to an embodiment of the invention, the rim protector 4 is positioned such that the ratio DP/DH between the diameter of said circumference and the bead diameter is within the range defined by the following formula:

$${d}_{min} \times {D}^{2} + {e}_{min} \times D + {f}_{min} \leq \frac{D P}{D H} \leq {d}_{max} \times {D}^{2} + {e}_{max} \times D + {f}_{max} ,$$

where D is said rim diameter, and

$${d}_{min} = 4.9 \; 12 \cdot {10}^{- 7} {mm}^{- 2}$$

$${e}_{min} = - 6.8 \; 90 \cdot {10}^{- 4} {mm}^{- 1}$$

$${f}_{min} = 1.315$$

$${d}_{max} = 6.5 \; 07 \cdot {10}^{- 7} {mm}^{- 2}$$

$${e}_{max} = - 9.1 \; 22 \cdot {10}^{- 4} {mm}^{- 1}$$

$${f}_{max} = 1.416 .$$

Preferably, the coefficients and constants in the formula defined above are

$${d}_{min} = 5.362 \cdot {10}^{- 7} {mm}^{- 2}$$

$${e}_{min} = - 7.5 \; 20 \cdot {10}^{- 4} {mm}^{- 1}$$

$${f}_{min} = 1.343$$

$${d}_{max} = 6.0 \; 54 \cdot {10}^{- 7} {mm}^{- 2}$$

$${e}_{max} = - 8.488 \cdot {10}^{- 4} {mm}^{- 1}$$

$${f}_{max} = 1.387 .$$

According to an embodiment of the invention, the angle α between the outer surface of the bead region 1 and the outer surface of the sidewall 2 of the tire 10 at the seam 3 of the bead region 1 and the sidewall 1 is at most 180 degrees. Preferably, the angle is at least 170 degrees. The bead 1 of the tire 10 has a width W from the toe of the bead region 1 to the laterally outwards facing rim contact area 1A of the bead region. According to an embodiment of the invention, the width W is 14.8-16.2 mm measured in a direction that is parallel to the rotation axis AXR of the tire 10. The width may be selected based on whether the tire 10 is provided with a single carcass ply or with two carcass plies 5, 6, as in the embodiments of the figures. If the tire 10 comprises a single carcass ply, the width W could be 14.8-15.2 mm and if the tire 10 comprises two carcass plies 5, 6, the width W could be 15.8-16.2 mm.

Table 1 below shows test result of a tire according to an embodiment of the invention compared to a tire having otherwise similar construction but not having the bead features according to the present invention.

TABLE 1

| | Comparative | Tire according to the |
|---|---|---|
| | example | invention |
| Dry handling performance | 100 | 103 |
| index | | |
| Wet handling performance | 100 | 101 |
| index | | |
| Snow handling performance | 100 | 102 |
| index | | |

Various properties of the tire according to the invention were tested on dry, wet and snowy surfaces. Similar tests were conducted for the reference tire forming the comparative example. The reference tire was given a performance index 100 for each of dry handling, wet handling and snow handling properties. By comparing the test results of the tire according to the invention to the corresponding test results of the reference tire, performance indexes were calculated for the tire according to the invention. As shown in the table above, all the performance indexes show improved performance. In particular, the performance of the tire in dry conditions was improved.

1. A radial tire for a passenger car or SUV, the tire being configured to be mounted onto a rim having a nominal diameter in the range of 13 to 24 inches, wherein the bead diameter (DH) of the bead region of the tire is 1.6-2.4 mm smaller than the rim diameter (D) specified for the corresponding rim size in the ETRTO standard for rims of passenger cars, LCVs and trailers.

2. The tire according to claim 1, wherein the bead diameter (DH) is 1.8-2.2 mm smaller than said rim diameter (D).

3. The tire according to claim 1, wherein the ratio DS/DH between the diameter (DS) of a seam between the bead region and the sidewall of the tire and said bead diameter (DH) is
$${a}_{min} \times {D}^{2} + {b}_{min} \times D + {c}_{min} \leq \frac{D S}{D H} \leq {a}_{max} \times {D}^{2} + {b}_{max} \times D + {c}_{max} ,$$
where D is said rim diameter, and
$${a}_{min} = 4.237 \cdot {10}^{- 7} {mm}^{- 2}$$
$${b}_{min} = - 5.944 \cdot {10}^{- 4} {mm}^{- 1}$$
$${c}_{min} = 1.2 \; 72$$
$${a}_{max} = 4.7 \; 69 \cdot {10}^{- 7} {mm}^{- 2}$$
$${b}_{max} = - 6.6 \; 86 \cdot {10}^{- 4} {mm}^{- 1}$$
$${c}_{max} = 1.305 .$$

4. The tire according to claim 3, wherein
$${a}_{min} = 4.264 \cdot {10}^{- 7} {mm}^{- 2}$$
$${b}_{min} = - 5.981 \cdot {10}^{- 4} {mm}^{- 1}$$
$${c}_{min} = 1.2 \; 73$$
$${a}_{max} = 4.7 \; 41 \cdot {10}^{- 7} {mm}^{- 2}$$
$${b}_{max} = - 6.6 \; 48 \cdot {10}^{- 4} {mm}^{- 1}$$
$${c}_{max} = 1.303 .$$

5. The tire according to claim 1, wherein the sidewall of the tire is provided with a protrusion forming a rim protector located radially outwards from a seam between the bead region and the sidewall of the tire.

6. The tire according to claim 5, wherein the rim protector comprises a tip having an inner edge and an outer edge, the inner edge being located closer to the rotation axis (AXR) of the tire than the outer edge, and the lateral distance (L) from a laterally outwards facing rim contact area of the bead region of the tire to said inner edge of the tip of the rim protector is 13.5-20.0 mm.

7. The tire according to claim 6, wherein said lateral distance (L) is 15.5-18.0 mm.

8. The tire according to claim 5, wherein the ratio DP/DH between the diameter (DP) of the circumference where an inner edge of a tip of the rim protector is located and the bead diameter (DH) is
$${d}_{min} \times {D}^{2} + {e}_{min} \times D + {f}_{min} \leq \frac{D P}{D H} \leq {d}_{max} \times {D}^{2} + {e}_{max} \times D + {f}_{max} ,$$
where D is said rim diameter, and
$${d}_{min} = 4.9 \; 12 \cdot {10}^{- 7} {mm}^{- 2}$$
$${e}_{min} = - 6.8 \; 90 \cdot {10}^{- 4} {mm}^{- 1}$$
$${f}_{min} = 1.315$$
$${d}_{max} = 6.5 \; 07 \cdot {10}^{- 7} {mm}^{- 2}$$
$${e}_{max} = - 9.1 \; 22 \cdot {10}^{- 4} {mm}^{- 1}$$
$${f}_{max} = 1.416 .$$

9. The tire according to claim 8, wherein
$${d}_{min} = 5.362 \cdot {10}^{- 7} {mm}^{- 2}$$
$${e}_{min} = - 7.5 \; 20 \cdot {10}^{- 4} {mm}^{- 1}$$
$${f}_{min} = 1.343$$
$${d}_{max} = 6.0 \; 54 \cdot {10}^{- 7} {mm}^{- 2}$$
$${e}_{max} = - 8.488 \cdot {10}^{- 4} {mm}^{- 1}$$
$${f}_{max} = 1.387 .$$

10. The tire according to claim 1, wherein the angle (α) between the outer surface of the bead region and the outer surface of the sidewall of the tire at the seam of the bead region and the sidewall is at most 180 degrees.

11. The tire according claim 10, wherein the angle (α) between the bead region and the sidewall is at least 170 degrees.

12. The tire according to claim 1, wherein the bead width (W) from the toe of the bead region of the tire to a laterally outwards facing rim contact area of the bead region is 14.8-16.2 mm measured in a direction that is parallel to the rotation axis (AXR) of the tire.

13. The tire according to claim 12, wherein said bead width (W) is 14.8-15.2 mm in case the tire comprises a single carcass ply and 15.8-16.2 mm in case the tire comprises two carcass plies.

14. The tire according to claim 2, wherein the ratio DS/DH between the diameter (DS) of a seam between the bead region and the sidewall of the tire and said bead diameter (DH) is
$${a}_{min} \times {D}^{2} + {b}_{min} \times D + {c}_{min} \leq \frac{D S}{D H} \leq {a}_{max} \times {D}^{2} + {b}_{max} \times D + {c}_{max} ,$$
where D is said rim diameter, and
$${a}_{min} = 4.237 \cdot {10}^{- 7} {mm}^{- 2}$$
$${b}_{min} = - 5.944 \cdot {10}^{- 4} {mm}^{- 1}$$
$${c}_{min} = 1.2 \; 72$$
$${a}_{max} = 4.7 \; 69 \cdot {10}^{- 7} {mm}^{- 2}$$
$${b}_{max} = - 6.6 \; 86 \cdot {10}^{- 4} {mm}^{- 1}$$
$${c}_{max} = 1.305 .$$

15. The tire according to claim 14, wherein
$${a}_{min} = 4.264 \cdot {10}^{- 7} {mm}^{- 2}$$
$${b}_{min} = - 5.981 \cdot {10}^{- 4} {mm}^{- 1}$$
$${c}_{min} = 1.2 \; 73$$
$${a}_{max} = 4.7 \; 41 \cdot {10}^{- 7} {mm}^{- 2}$$
$${b}_{max} = - 6.6 \; 48 \cdot {10}^{- 4} {mm}^{- 1}$$
$${c}_{max} = 1.303 .$$

16. The tire according to claim 5, wherein the angle (α) between the outer surface of the bead region and the outer surface of the sidewall of the tire at the seam of the bead region and the sidewall is at most 180 degrees.

17. The tire according to claim 16, wherein the angle (α) between the outer surface of the bead region and the outer surface of the sidewall of the tire at the seam of the bead region and the sidewall is at most 180 degrees.
